(19) United States
(12) Patent Application Publication
(10) Pub. No.: US 2013/0232200 A1
(43) Pub. Date: Sep. 5, 2013

(54) USER AND CONTENT RECOMMENDATION AND DISCOVERY APPLICATION

(71) Applicant: MYSPACE LLC, Beverly Hills, CA (US)

(72) Inventor: Jason J.A. Knapp, Solana Beach, CA (US)

(73) Assignee: MYSPACE LLC, Beverly Hills, CA (US)

(21) Appl. No.: 13/786,173

(22) Filed: Mar. 5, 2013

Related U.S. Application Data
(60) Provisional application No. 61/606,869, filed on Mar. 5, 2012.

(51) Int. Cl. H04L 29/08

(52) U.S. Cl. CPC H04L 67/306
USPC 709/204

(57) ABSTRACT

A method, system, and computer program product provide the ability to display a recommendation. A first user profile for a first user and a second profile are obtained. The first user profile is compared to the second profile to find similar properties. A recommendation is determined based on the similar properties. The recommendation is displayed to the first user.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Patent Application Ser. No. 61/606,869, entitled “USER AND CONTENT RECOMMENDATION AND DISCOVERY APPLICATION”, by Jason J. A. Knapp, filed on Mar. 5, 2012, Attorney Docket No. 257.8-US-P1.

### BACKGROUND OF THE INVENTION

1. Field of the Invention

The present invention relates generally to social media content, and in particular, to a method, apparatus, and article of manufacture for recommending and discovering media content and other users based on social media data/profile and user actions.

2. Description of the Related Art

Social networking websites are websites that allow users to interact with one another and build relationships. Users identify “friends” that may have accounts/websites on a social networking site. Users may post status updates or information on a website that can be seen by their friends, friends of friends, or may be publicly accessible (depending on the poster's security settings). Commonly, the social networking sites provide the ability for users to reconnect with and communicate with relatives, friends, and acquaintances. Using social networking/media, users can find friends by searching for particular names, examining lists of other's friends, and or viewing recommendations generated by a social media application (which may base its suggestion on friends and friends of friends). Alternatively, users can view lists of persons that attended a particular school and/or worked at a particular workplace at a particular time. Regardless of the techniques used to find friends, prior art methods enable users to locate persons that the user has had contact with or knows in the real world.

In addition to discovering people, some prior art social networking applications/websites provide the ability for users to view media content that is currently being viewed/played by other persons/friends. For example, a status update may notify a user that the user's friend “John Smith” is currently listening to a particular song or a particular artist.

What is missing from the prior art is the ability for a user to discover potential friends that may have similar interests to the user based on the user's actions and preferences. Further, the prior art fails to provide a mechanism to discover new media content (e.g., artist and/or song) based on preferences and actions of other users that may/may not be that user's friends.

In view of the above, what is needed is a capability to discover new friends and new content that the user may be interested in based on similar properties between the user and the potential friends where no preexisting connection or relationship/nexus between the two parties exist.

### SUMMARY OF THE INVENTION

Based on the aggregation of media content (e.g., music) viewed/listened to by a user, and the comparison of social media data including the aggregations, personal recommendations of both content and other users are provided to the user.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIGS. 3A, 3B, and 3C illustrate options for suggesting or providing the user with potential new content in accordance with one or more embodiments of the invention;

FIG. 4 illustrates a display of similar attributes between a first user and a second user in accordance with one or more embodiments of the invention;

FIG. 5 illustrates an exemplary discovery bar that is displayed in accordance with one or more embodiments of the invention;

FIG. 6 illustrates an exemplary dialog that can be used to set the recommendation preferences in accordance with one or more embodiments of the invention; and

FIG. 7 illustrates the logical flow for displaying recommendations to a user in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

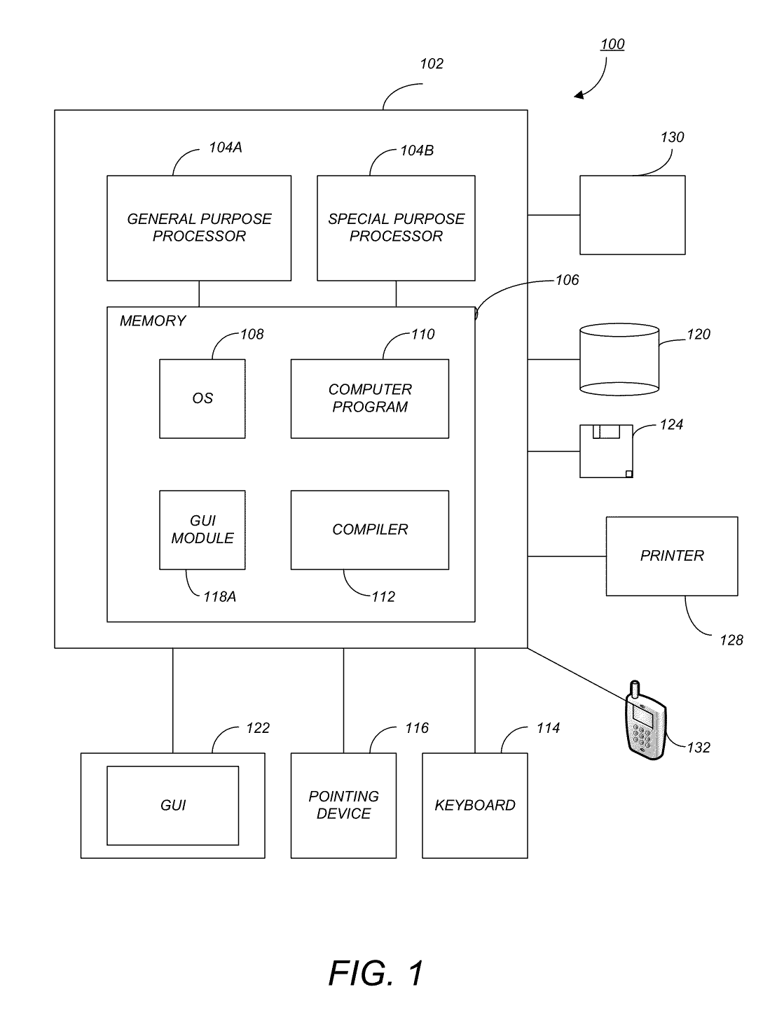

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may comprise or may be coupled to and/or integrated with other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to or may comprise a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

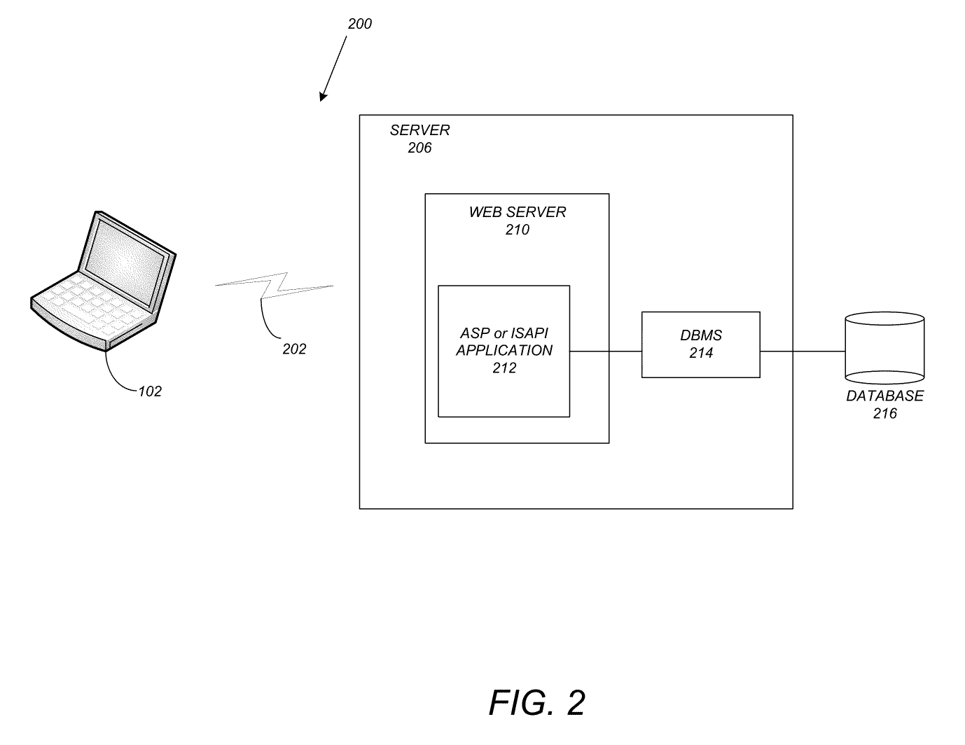

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 in accordance with embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 102 may be downloaded from server computer 206 to client computers 102 and installed as a plug in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of or connected directly to client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include thin client devices with limited or full processing capabilities, portable devices such as cell phones, notebook computers, pocket computers, multi-touch devices, and/or any other device with suitable processing, communication, and input/output capability.

Of course, those skilled in the art will recognize that any combination of the above components, or any number of different components, peripherals, and other devices, may be used with computers 102 and 206.

### Content/User Discovery

Embodiments of the invention provide the ability for users to discover new content and users based on a comparison between the media content viewed/listened to by the user and social media data.

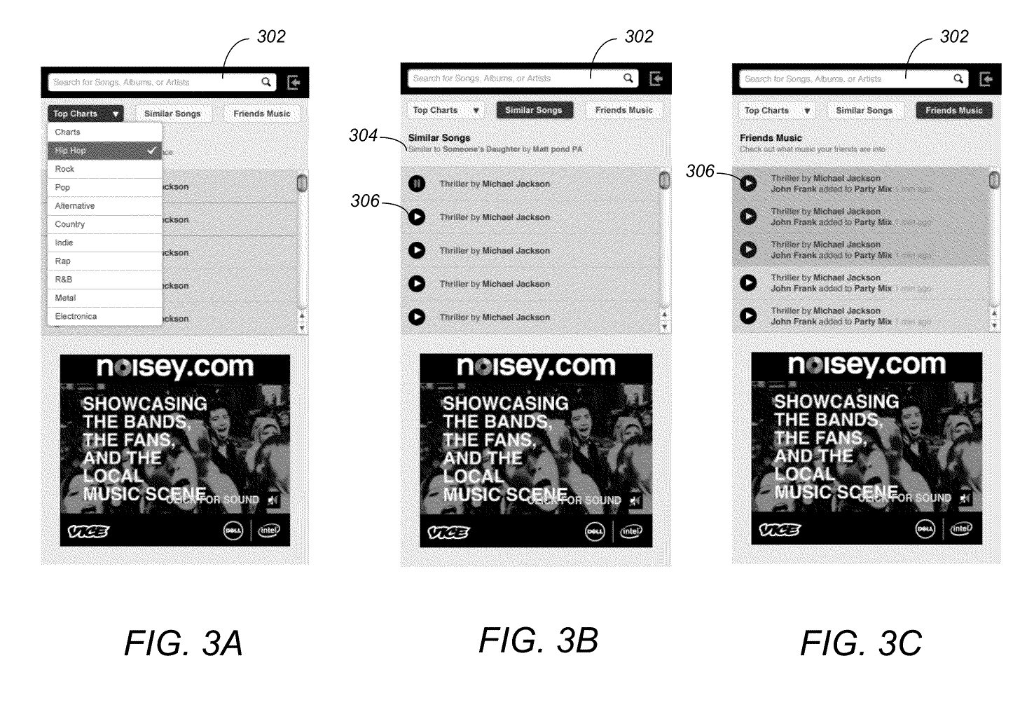

Various different methodologies may be used to deliver new content to a user. FIGS. 3A, 3B, and 3C illustrate options for suggesting or providing the user with potential new content. The graphical user interfaces illustrated in FIGS. 3A-3C may be displayed as part of a music player, an expandable portion of a music player, or may be independently displayed on a web page or via an application on a user/client 102/132. The user 102/132 can opt to search directly for songs, albums, or artists using text box 302.

In FIG. 3A, the user 102/132 has elected to select the “Top Charts” option to find songs. Such an option allows the user 102/132 to select the desired genre and view the resulting music in the top charts in the selected genre.

In FIG. 3B, the “Similar Songs” option is selected by the user 102/132. The similar songs option displays what songs that are similar to another song preferred/“liked” by the user 102/132 (e.g., that is currently being played in a music player by the user 102/132). In this regard, the text 304 indicates that the songs below are similar to “Someone's Daughter” by “Matt pond PA”. Below the text 304 are the list of songs that are similar along with options to play/pause the song in a media player (e.g., using icon/play/pause button 306).

In FIG. 3C, the user 102/132 has selected the “Friends Music” option that provides the ability for the user 102/132 to check out what music the user's friends prefer/like/are “into”. Below the selection and text explaining the “Friends Music” option, is the list of songs based on friend's preferences. Similar to FIG. 3B, the user can opt to play the song in a media player by selecting icon/play/pause button 306.

Based on FIGS. 3A-3C, one may note that embodiments of the invention provide the ability to view what other people are playing (i.e., persons that are both friends and others). Such song listings may be aggregated by friend, genre, artist, song, etc. Such an ability to aggregate and display media content that the user may like is not available in the prior art.

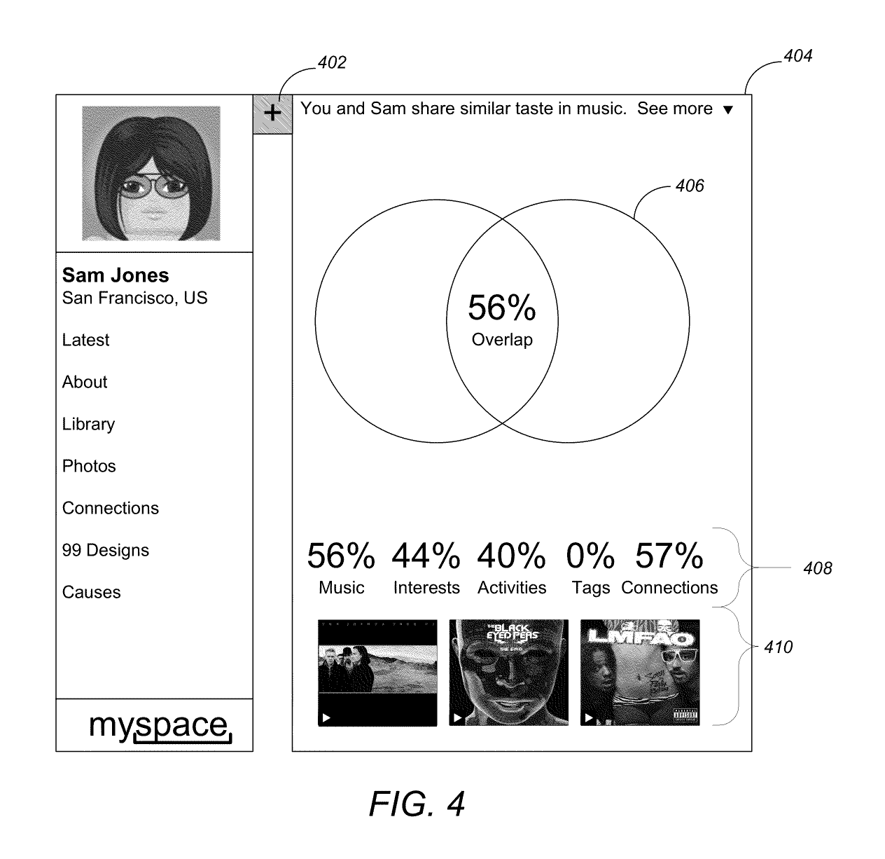

FIG. 4 illustrates a display of similar attributes between a first user and a second user in accordance with one or more embodiments of the invention. In FIG. 4, a first user may opt to look at the profile of a second user, Sam Jones. To view the similarity, the first user may click on the “+” icon 402 causing the display to expand and display window 404 (e.g., window 404 slides out). Similarity window 404 indicates that the user and Sam share similar taste in music with the option to see more. A Venn diagram 406 may be displayed that indicates the percentage overlap in similarities (for a specific item or on average). In FIG. 4, the Venn diagram 406 indicates that there is a 56% overlap between the attributes of Sam and the user. Various other statistics 408 may also be displayed to the user such as the similarity in music (e.g., 56%), interests (e.g., 44%), activities (e.g., 40%), tags (e.g., 0%), and/or connections (e.g., 57%). Similarity window 400 may also include various icons 410 that allows the user to select music that is recommended based on the similarities. The window 404 may also be a right rail window of a website. A right rail is the common name for the right-side column of a web page and is often where sponsored listings and advertisements appear. Accordingly, in embodiments of the invention, the right rail may also contain recommendations for users and/or content.

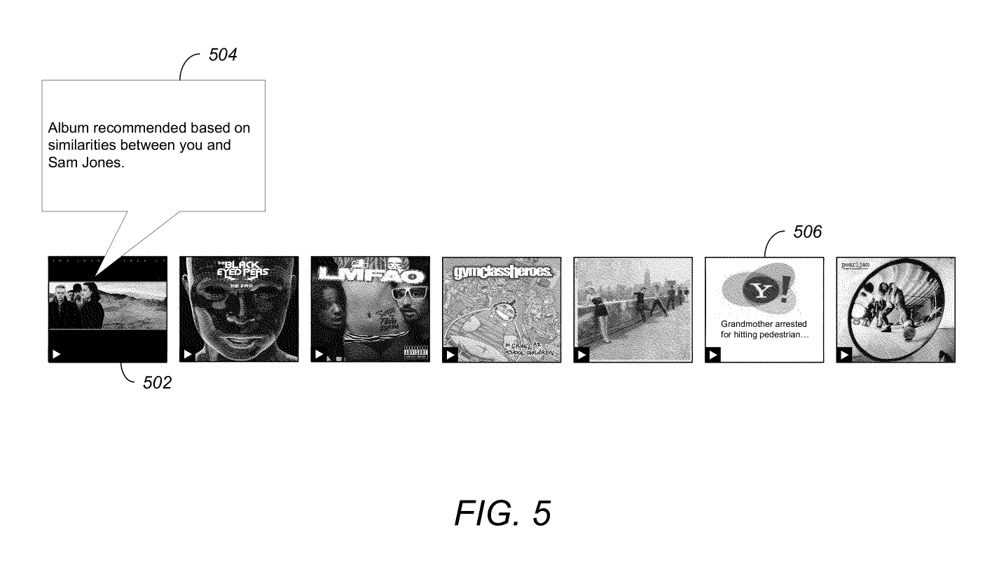

In addition to (or instead of) the window of FIG. 4, a bar or dialog window may be displayed that includes a series of icons/glyphs that attempt to promote the discovery of content (e.g., music, articles, artists, etc.) and people at the same time. Such a bar or dialog window may be displayed in the right rail or may also be displayed across the bottom of the screen. An example of such a discovery bar is illustrated in FIG. 5. Rather than promoting users to connect to people that the user knows in the real world (e.g., as in the Facebook™ social network or other social networks), the discovery bar is intended to promote connections with content and people that the user does not currently know in the real world based on similar tastes and interests.

Each icon/glyph in the discovery bar represents a recommendation to the user based on the user's profile, likes, and/or dislikes. The recommendation may be for a particular person, song, artist, concert, event, etc. Social data may then be combined with the aggregated data to recommend additional content and or to identify similar interests to another user.

As an example, based on the user listening to a particular series of songs, the system may determine that the user may like songs that user Sam Jones listens to and may recommend a song from Sam's playlist or may recommend Sam's playlist itself. The recommendation may also be for the user to befriend another person (e.g., Sam Jones) based on similar likes/dislikes. The recommendation may further be an implied suggestion that the user may want to start “following” a person of interest such as the articles the person reads, the music the person listens to, etc.

Returning to FIG. 5, the icons may each represent a recommended object that may be an album, an artist, a song, an article, a user, etc. A recommendation may also include a rationale/reason why an object is being recommended. Such a rationale/reason may be displayed/presented to the user in a variety of forms and based on a variety of actions. In one or more embodiments, the rationale/reason may be presented when a user hovers over a particular object/icon/glyph 502. Alternatively, the rationale/reason may be statically displayed with a recommendation.

The form in which the rationale/reason is displayed may also vary from a tooltip, to a Venn diagram, to a miniature Venn diagram, to highlighting, etc.

As an example, when a user hovers over a particular icon, a tooltip may appear that indicates why that particular item is recommended. For example, when hovering over icon 502, tooltip 504 may appear indicating that the album 502 is recommended based on similarities between the user and Sam Jones. Alternatively, rather than a tooltip, the icon 502 may be associated with another graphical indicator that indicates why or what is recommended. For example, text or miniature Venn diagrams such as that displayed in FIG. 4 may be displayed adjacent/nearby the icon/glyph 502 or alternatively may be displayed when the user hovers over the icon 502.

The discovery bar in FIG. 5 reflects various albums that may be suggested to the user. In addition, icon 506 represents an article (e.g., on Yahoo™) that is also recommended to the user. Accordingly, a recommendation engine (e.g., executing within web server 210 or by an application 212) may perform a comparison or evaluation between the user and other users. Such an evaluation may compare profiles of the users, music, interests, activities, tags, connections, and/or other attributes. Based on similar tastes in one or more categories, a user or a user's attributes may be recommended. Thus, if two users indicate a preference for a particular band and/or song, bands/songs preferred by one user but not yet listened to by a second user may be recommended. Beyond music, if various attributes (e.g., music preferences and/or other social media preferences/attributes) are commonly shared between two users, the recommendation engine may recommend: (1) one user follow the other user's blog/twitter account; (2) the users befriend each other; (3) one user befriend friends of the other user; (4) one user read an article read by the other user; (5) the playlists of each user to the other; (6) websites visited by the other user; (7) etc.

In view of the above, embodiments of the invention provide various types and formats of recommendations based on the similarities between users. Such recommendations serve to promote the discovery of both content and people in the virtual environment—in a manner that extends beyond merely connecting with or following those people that the user already knows in the real world. It allows users to meet new people and discover new content that such users would not otherwise be exposed to. The ability to provide such recommendations are based on the data maintained by a social network, the user's interaction with such a social network (e.g., music listened to).

In addition to the above, the social network data may be further evaluated in view of information provided by a network/Internet service provider (ISP). In this regard, all requests for data on the Internet for each user is processed by the user's ISP. The ISP may maintain information about those websites and data requested/provided by/to individual users. Such information may be evaluated/combined with the social network data in order to obtain a better landscape of the user's interests. Based on such a landscape, embodiments of the invention may provide a more accurate prediction of potential objects of interest for a user/group of users and thereby provide improved recommendations to such users.

Further, rather than comparing one user to other individual users, embodiments of the invention may compare a user to one or more groups of users. Such a comparison may be based on gender, occupation, residence location, work location, music genre preferences, etc. For example, if the user is a 35 year old female nurse, the recommendation engine may compare the user to 25-45 year old females working in the medical field. Attributes/properties of such persons, on average, may be determined and recommended to the user. Similarly, rather than recommending the preferences/music choices of a single user that listens to the same song as a first user, a group of users may be evaluated. For example, if two hundred (200) other users listened to the same song as a first user, the most commonly listened to songs amongst the 200 users may be used as the recommended content.

The order in which objects are recommended to a user (e.g., the order in which they appear in a discovery bar) may also be based on one or more factors. In one or more embodiments, those recommendations that are more likely to be preferred by the user based on similarities with the group/person the user is being compared to may have higher priority. For example, the recommendation engine may sort potential recommendations based on the higher percentage of similarities between the user and the user/group of users. The user may also have the option of determining how the recommendations are sorted (e.g., via highest percentage similarities, by individual users, by groups of users, alphabetically, by type of recommendation [e.g., music, articles, users, etc.]).

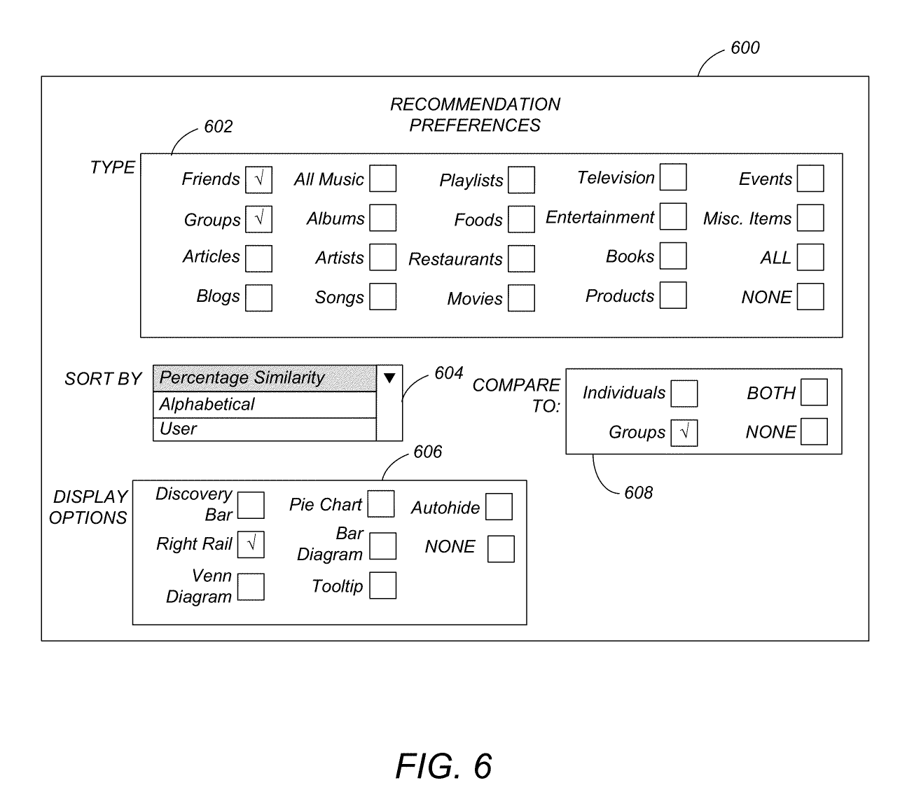

The user may also be provided with control over how and what recommendations are presented/displayed. FIG. 6 illustrates an exemplary dialog that can be used to set the recommendation preferences in accordance with one or more embodiments of the invention. Note that the preferences listed in window 600 are merely examples and the potential settings are not limited to those identified therein. As illustrated, the user may have the option of selecting the type 602 of recommendations 602 that may be presented including friends, groups, articles, blogs, all music, albums, artists, songs, playlists, foods, restaurants, movies, television, entertainment, books, products, events, miscellaneous items, all items, none, etc. The user may further have the option to sort 604 the recommendations by (e.g., by percentage similarity, alphabetically, by user, etc.). Display options 606 may be used to determine how the recommendations are presented to the user (e.g., via discovery bar, right rail, Venn diagram, pie chart, bar diagram, tooltip, autohide, none, etc.). In addition, the user can determine who to compare to 608 to determine the recommendations (e.g., individuals, groups of users, both, or none). In addition, further options may be available in window 600 to determine the size of the recommendations (e.g., maximized, minimized) and when to display the recommendations (e.g., never, autohide, hovering required, etc.). The size of the recommendations may also be established using standard resizing tools (e.g., dragging the mouse to expand/reduce the size of the recommendations).

### Logical Flow

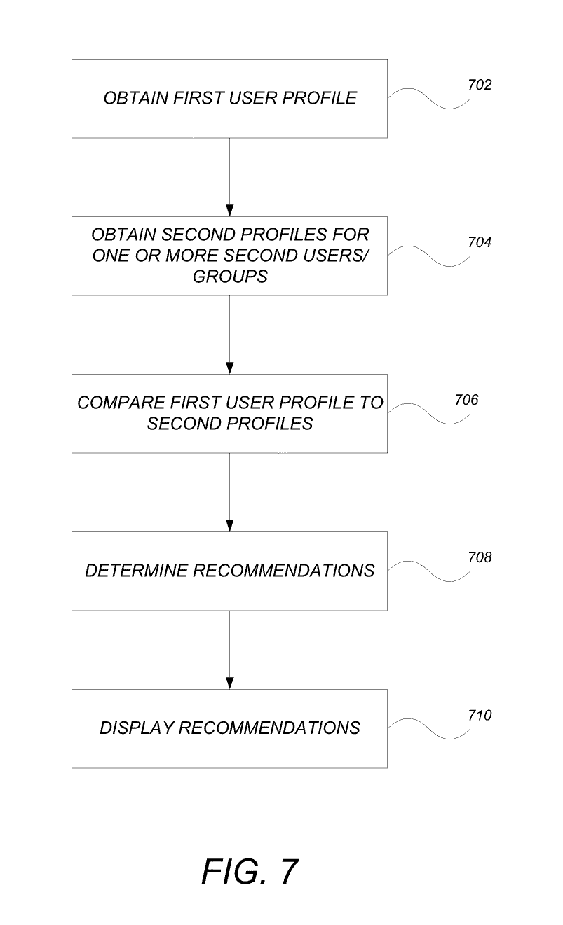

FIG. 7 illustrates the logical flow for displaying recommendations to a user in accordance with one or more embodiments of the invention.

At step 702, the first user profile is obtained. As described above, the profile may include music preferences, political affiliations/preferences, book preferences, and/or any additional attributes that may be used to determine similarities with other users/content.

At step 704, the profiles of one or more second users or groups/categories of users are obtained.

At step 706, the first user profile is compared to the profiles of the second users/groups/categories of users. Such a comparison may evaluate the similarities between the first user and a particular second user. Alternatively, the comparison may be between the first user and a group of users. In yet another embodiment, the comparison is not conducted based on the users but instead, the profiles may be indexed based on the properties and the indexed properties from multiple users are compared to find similar profiles. Such a comparison based on the profiles/properties enables a recommendation engine to find properties/groups of properties that are similar. Such a comparison may also look for similar demographics amongst users/groups of users.

Once similar profiles/properties are found, recommendations can be determined at step 708. Such recommendations may be for new media content (e.g., music, album, artist, videos, etc.), a new user/friend, an event (e.g., concert, sporting event, etc.), a destination (e.g., a travel/vacation destination), or any type or recommendation that can be based on similar profiles/preferences between multiple users.

At step 710, the recommendations are displayed/provided to the user. Such a display may include a right rail, a discovery bar, a pop-up, etc. Further, the display may also include the reason/rationale for the basis of the recommendation.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for displaying a recommendation comprising:
obtaining a first user profile for a first user;
obtaining a second profile;
comparing the first user profile to the second profile to find similar properties;
determining a recommendation based on the similar properties; and
displaying the recommendation to the first user.

2. The method of claim 1, wherein the first user profile comprises one or more attributes of the first user.

3. The method of claim 1, wherein the second profile is for a second user.

4. The method of claim 1, wherein the second profile is for a group of second users.

5. The method of claim 1, wherein the second profile is an aggregation and categorization of data.

6. The method of claim 5, wherein the categorization is music related.

7. The method of claim 5, wherein the categorization is based on a common attribute for a group of second users.

8. The method of claim 1, wherein the comparing comprises:
indexing the first user profile;
indexing the second user profile; and
comparing indexed properties from the first user profile and the second user profile to find the similar properties.

9. The method of claim 1, wherein the comparing and determining steps are based on a set of user-specified preferences.

10. The method of claim 1, wherein the recommendation is for new media content.

11. The method of claim 1, wherein the recommendation is for a new friend.

12. The method of claim 1, wherein the recommendation is for an event.

13. The method of claim 1, wherein the recommendation is for a destination.

14. The method of claim 1, wherein the displaying comprises:
displaying the recommendation; and
upon selection of the recommendation, displaying a rational for the recommendation.

15. The method of claim 1, wherein the displaying comprises:
sorting a list of recommendations based on a user-defined preference.

16. A system for displaying a recommendation comprising:
(a) a server computer; and
(b) a recommendation application executing on the server computer,
wherein the recommendation application is configured to:
obtain a first user profile for a first user;
obtain a second profile;
compare the first user profile to the second profile to find similar properties;
determine a recommendation based on the similar properties; and
display the recommendation to the first user.

17. The system of claim 16, wherein the first user profile comprises one or more attributes of the first user.

18. The system of claim 16, wherein the second profile is for a second user.

19. The system of claim 16, wherein the second profile is for a group of second users.

20. The system of claim 16, wherein the second profile is an aggregation and categorization of data.

21. The system of claim 20, wherein the categorization is music related.

22. The system of claim 20, wherein the categorization is based on a common attribute for a group of second users.

23. The system of claim 16, wherein the recommendation application is configured to compare by:
indexing the first user profile;
indexing the second user profile; and
comparing indexed properties from the first user profile and the second user profile to find the similar properties.

24. The system of claim 16, wherein recommendation application is configured to compare and determine based on a set of user-specified preferences.

25. The system of claim 16, wherein the recommendation is for new media content.

26. The system of claim 16, wherein the recommendation is for a new friend.

27. The system of claim 16, wherein the recommendation is for an event.

28. The system of claim 16, wherein the recommendation is for a destination.

29. The system of claim 16, wherein the recommendation application is configured to display by:
displaying the recommendation; and
upon selection of the recommendation, displaying a rational for the recommendation.

30. The system of claim 16, wherein the recommendation application is configured to display by:
sorting a list of recommendations based on a user-defined preference.
